(19) United States
(12) Patent Application Publication
(10) Pub. No.: US 2026/0099660 A1
(43) Pub. Date: Apr. 9, 2026

(54) METHODS OF (I) DETERMINING WIRE LOOP SHAPES FOR A SEMICONDUCTOR PACKAGE AND OF (II) GENERATING A SEMICONDUCTOR PACKAGE DESIGN

(71) Applicant: Kulicke and Soffa Industries, Inc., Fort Washington, PA (US)

(72) Inventors: Basil Milton, Furlong, PA (US); David Li, Ambler, PA (US); Odal Kwon, Blue Bell, PA (US); Ray L. Cathcart, Elkins Park, PA (US); Pavel Shusharin, Philadelphia, PA (US)

(73) Assignee: Kulicke and Soffa Industries, Inc., Fort Washington, PA (US)

(21) Appl. No.: 19/343,156

(22) Filed: Sep. 29, 2025

Related U.S. Application Data
(60) Provisional application No. 63/703,241, filed on Oct. 4, 2024.

(51) Int. Cl. G06F 30/398; G06F 30/392; G06F 113/18; G06F 117/12

(52) U.S. Cl. CPC G06F 30/398; G06F 30/392; G06F 2113/18; G06F 2117/12

(57) ABSTRACT

A method of determining wire loop shapes for a plurality of wire loops configured to be included in a semiconductor package is provided. The method includes the steps of: (a) providing package data related to the semiconductor package; and (b) generating wire loop shapes for each of the plurality of wire loops using the package data provided in step (a).

### CROSS-REFERENCE TO RELATED APPLICATION

This application claims the benefit of U.S. Provisional Application No. 63/703,241, filed on Oct. 4, 2024, the content of which is herein incorporated by reference.

### FIELD

The invention relates to wire bonding operations, and in particular, to methods of (i) determining wire loop shapes for a semiconductor package and (ii) generating a semiconductor package design.

### BACKGROUND

Wire bonding systems are used to form wire loops between respective locations to be electrically interconnected. Exemplary wire bonding techniques include ball bonding and wedge bonding. Steps in a typical ball bonding application include: bonding a free air ball to a first bond location of a workpiece (e.g., a die pad of a semiconductor die); extending a length of wire continuous with the bonded free air ball to a second bond location of the workpiece (e.g., a lead of a leadframe); and bonding the wire to the second bond location, thereby forming a wire loop between the first bond location and the second bond location. In forming the bonds between (a) the ends of the wire loop and (b) the bond sites (e.g., die pads, leads, etc.) varying types of bonding energy may be used including, for example, ultrasonic energy, thermosonic energy, thermo-compressive energy, amongst others.

Many developments have been made in connection with the optimization of wire looping and/or wire bonding processes. Exemplary developments are described in: U.S. Pat. No. 10,325,878 (entitled “METHODS FOR GENERATING WIRE LOOP PROFILES FOR WIRE LOOPS, AND METHODS FOR CHECKING FOR ADEQUATE CLEARANCE BETWEEN ADJACENT WIRE LOOPS”); U.S. Pat. No. 9,496,240 (entitled “SYSTEMS AND METHODS FOR OPTIMIZING LOOPING PARAMETERS AND LOOPING TRAJECTORIES IN THE FORMATION OF WIRE LOOPS”); U.S. Pat. No. 8,302,840 (entitled “CLOSED LOOP WIRE BONDING METHODS AND BONDING FORCE CALIBRATION”); U.S. Patent Application Publication No. 2012/0074206 (entitled “METHODS OF FORMING WIRE BONDS FOR WIRE LOOPS AND CONDUCTIVE BUMPS”); U.S. Patent Application Publication No. 2023/0325552 (entitled “METHODS OF DETERMINING SUITABILITY OF A WIRE BONDING TOOL FOR A WIRE BONDING APPLICATION, AND RELATED METHODS”); U.S. Pat. No. 12,183,711 (entitled “METHODS OF DETERMINING A SEQUENCE FOR CREATING A PLURALITY OF WIRE LOOPS IN CONNECTION WITH A WORKPIECE”); and U.S. Patent Application Publication No. 2023/0325578 (entitled “METHODS OF DETERMINING AN EFFECT OF ELECTRONIC COMPONENT PLACEMENT ACCURACY ON WIRE LOOPS IN A SEMICONDUCTOR PACKAGE, AND RELATED METHODS”).

It would be desirable to provide improved methods related to forming a plurality of wire loops in connection with a workpiece, and improved methods of designing a semiconductor package.

### SUMMARY

According to an exemplary embodiment of the invention, a method of determining wire loop shapes for a plurality of wire loops configured to be included in a semiconductor package is provided. The method includes the steps of: (a) providing package data related to the semiconductor package; and (b) generating wire loop shapes for each of the plurality of wire loops using the package data provided in step (a).

According to an exemplary embodiment of the invention, a method of generating a semiconductor package design including a plurality of wire loops is provided. The method includes the steps of: (a) providing package data related to the semiconductor package; (b) generating wire loop shapes for each of the plurality of wire loops using the package data provided in step (a); and (c) providing design information related to a height of the semiconductor package based on the wire loop shapes generated in step (b).

According to other embodiments of the invention, the methods recited in the immediately preceding two paragraphs may have any one or more of the following features: the wire loop shapes are three-dimensional wire loop shapes; the wire loop shapes include three-dimensional locations for each of a plurality of bends configured to be included in each of the plurality of wire loops; the wire loop shapes further include a length of wire to be included between each of the plurality of bends; the wire loop shapes include wire lengths for each of a plurality of sections of each of the plurality of wire loops; the wire loop shapes include bends in multiple planes of the semiconductor package; the package data includes locations of wire bonds of each of the plurality of wire loops; the package data includes thickness values related to at least one of (i) a semiconductor element in the semiconductor package and (ii) the semiconductor package; the package data includes tier values for bonding locations configured to receive wire bonds in connection with formation of the plurality of wire loops; the package data includes position data related to components included in the semiconductor package; the package data includes at least one two-dimensional drawing including a wire layout for the semiconductor package; the package data includes a maximum loop height specification for the semiconductor package; step (a) includes teaching locations of wire bonds of each of the plurality of wire loops; further comprising the step of generating loop tier values for each of the plurality of wire loops using the package data provided in step (a); step (b) includes generating the wire loop shapes for each of the plurality of wire loops in an effort to minimize a height of the semiconductor package; and step (b) includes generating the wire loop shapes for each of the plurality of wire loops in an effort to optimize spacing in the semiconductor package.

### BRIEF DESCRIPTION OF THE DRAWINGS

The invention is best understood from the following detailed description when read in connection with the accompanying drawings. It is emphasized that, according to common practice, the various features of the drawings are not to scale. On the contrary, the dimensions of the various features are arbitrarily expanded or reduced for clarity.

Included in the drawings are the following figures:

FIG. 1A is a block diagram side view of a wire bonding system during the formation of a plurality of wire loops on a workpiece useful for explaining methods in accordance with various exemplary embodiments of the invention;

FIGS. 1B-1D are detailed views of portions of FIG. 1A including various wire loops;

FIGS. 2A-2B are side and top views of the workpiece of FIG. 1A useful in explaining methods in accordance with various exemplary embodiments of the invention;

FIGS. 3A-3B are block diagram cut away side views of workpieces useful in explaining methods in accordance with various exemplary embodiments of the invention; and

FIG. 4 is a flow diagram illustrating a method of generating and/or determining wire loop shapes in accordance with various exemplary embodiments of the invention.

### DETAILED DESCRIPTION

According to various exemplary embodiments of the invention, methods of automatically determining and/or optimizing a wire loop shape for each of a plurality of wire loops in a semiconductor package is provided. Conventionally wire loop shapes are manually generated by an operator. In accordance with aspects of the invention, the wire loop shapes are automatically determined and/or generated (and in some embodiments, automatically optimized) based on input information (i.e., package data related to a semiconductor package).

For example, wire loop shapes (e.g., optimal wire loop shapes) may be generated using package data such as 2D wire locations (e.g., 1^{st} bond and 2^{nd} bond locations of each wire loop), die thickness information, overall package thickness information, etc.

This package data may be used as an input to an algorithm(s) that generates 3D wire loop shapes. Further, the algorithm(s) may be used to iteratively improve the wire loop shapes to achieve a desired and/or optimal shape—based on criteria such as optimal spacing of wire loops in a semiconductor package, minimization of a height of the semiconductor package, among others.

Through the use of the inventive techniques disclosed herein, an automatic wire loop generation process, and related automatic processes are provided which result in improved performance of a semiconductor package and a reduced time-to-market.

Certain embodiments are best described in connection with the drawings. Throughout the various drawings, like reference numerals refer to like elements unless specifically indicated otherwise.

As used herein, the term “semiconductor element” is intended to refer to any structure including (or configured to include at a later step) a semiconductor chip or die. Exemplary semiconductor elements include a bare semiconductor die, a semiconductor die on a substrate (e.g., a leadframe, a PCB, a carrier, a semiconductor chip, a semiconductor wafer, a BGA substrate, a semiconductor element, etc.), a packaged semiconductor device, a flip chip semiconductor device, a die embedded in a substrate, a stack of semiconductor die, amongst others. Further, the semiconductor element may include an element configured to be bonded or otherwise included in a semiconductor package (e.g., a spacer to be bonded in a stacked die configuration, a substrate, etc.).

As used herein, the term “electronic component” is intended to refer to any component configured to be “placed” on or “bonded” to a substrate of a semiconductor package. Exemplary electronic components include semiconductor elements (e.g., semiconductor die), SMT (surface mount technology) components, passive components (e.g., capacitors, transistors, diodes, etc.), etc.

As used herein, the term “substrate” is intended to refer to any structure to which a semiconductor element and/or other electronic component may be bonded or otherwise placed. Exemplary substrates include, for example, a leadframe, a printed circuit board (PCB), a carrier, a module, a semiconductor chip, a semiconductor wafer, a BGA substrate, another semiconductor element, etc.

As used herein, the term “package data” is intended to refer to data related to a given semiconductor package. Examples of information included in such package data may include a two-dimensional (and/or three-dimensional) wire layout of the semiconductor package, electronic component (e.g., die) height, bonding locations of an electronic component (e.g., die pad locations), bonding locations of a substrate (e.g., lead locations of a leadframe), relative distances between first bonding locations and second bonding locations, wire diameter, and wire type. Package data may be provided in various ways, for example: (i) a computer aided design (“CAD”) model; (ii) an online teaching reference system model (or derivations thereof), (iii) a data structure, and the like.

Specific data that may be included in the package data are: thickness values related to at least one of (i) a semiconductor element in the semiconductor package and (ii) the semiconductor package; loop tier values for each of the plurality of wire loops; position data related to components (e.g., spacers, electronic components, etc.) included in the semiconductor package; at least one two-dimensional drawing including a wire layout for the semiconductor package; and/or a maximum loop height specification for the semiconductor package.

As used herein, the term “semiconductor package” is intended to refer to any workpiece including a semiconductor element. It will be appreciated that certain semiconductor packages (as illustrated and described herein) are not shown as fully “packaged”, but rather in a state of partial assembly for purposes of illustration and simulation. While the invention is illustrated and described herein primarily with respect to simple semiconductor packages (e.g., a semiconductor element on a substrate, such as a semiconductor die on a leadframe), it is not limited thereto. Aspects of the invention have particular applicability to more complicated semiconductor packages such as high-pin count packages, stack die packages, SiP packages, SMT packages, etc.

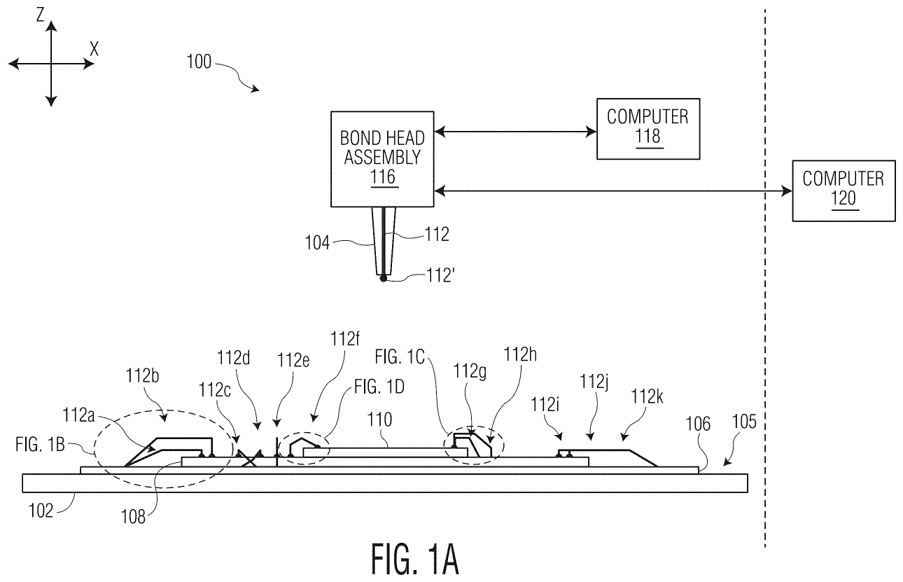

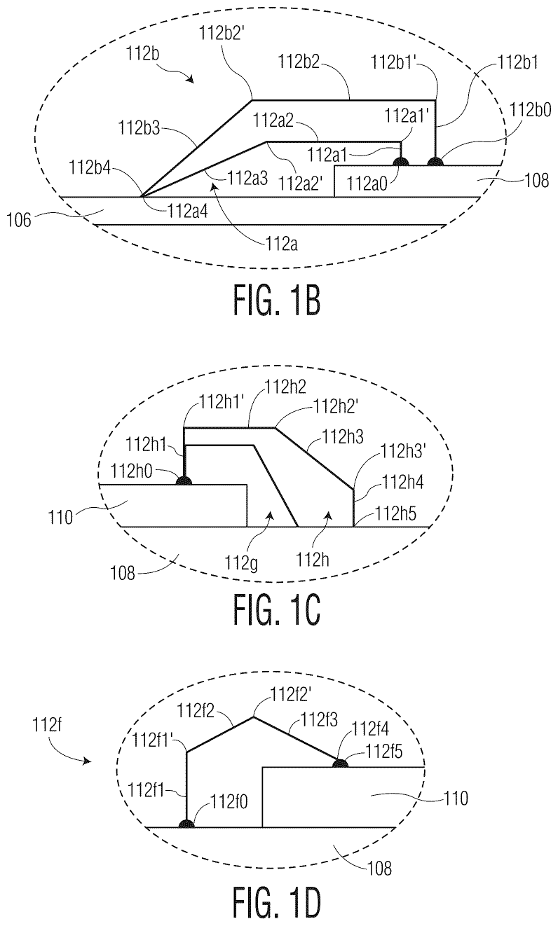

Referring now to the drawings, FIG. 1A illustrates a wire bonding system 100 and a computer 120 (external to wire bonding system 100, but communicatively connected to wire bonding system 100 (e.g., connected by a local network, connected via the Internet, etc.)). Wire bonding system 100 includes a support structure 102 (e.g., a heat block, etc.) for supporting a workpiece 105. Example workpiece 105 shown in FIG. 1A includes a substrate 106 (e.g., a leadframe, including bonding locations labelled as leads 106a), a semiconductor element 108 (e.g., a semiconductor die, including bonding locations labelled as bond pads 108a) supported by substrate 106, and a semiconductor element 110 (e.g., a semiconductor die, including bonding locations labelled as bond pads 110a) supported by semiconductor element 108. Wire bonding system 100 also includes a bond head assembly 116 and a computer 118.

Bond head assembly 116 carries a wire bonding tool 104 (e.g., a capillary). Wire 112 (e.g., from a wire spool) is engaged with wire bonding tool 104. An end portion of wire 112 has been formed into a free air ball (FAB) 112′, for example, to form a first bond of a wire loop.

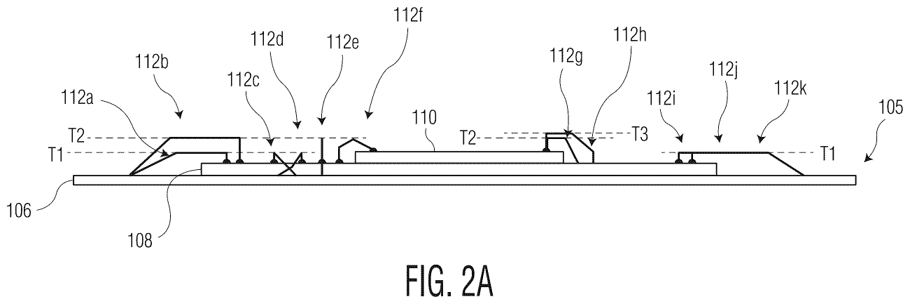

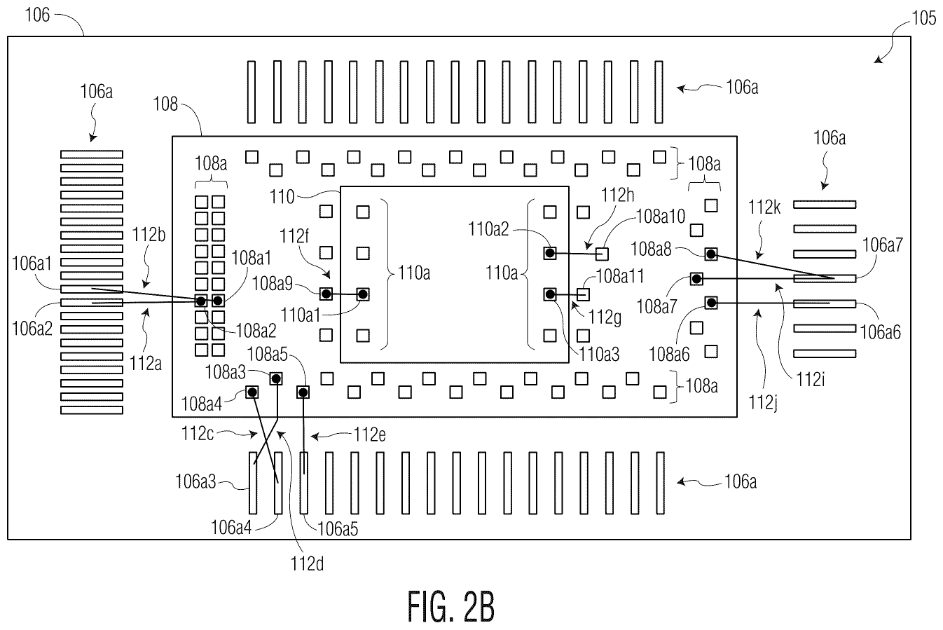

In connection with the example workpiece 105 shown in FIG. 1A, a plurality of wire loops 112a, 112b, 112c, 112d, 112e, 112f, 112g, 112h, 112i, 112j, and 112k have been formed using wire bonding tool 104. Portions of FIG. 1A (illustrating various of the plurality of wire loops) are detailed in FIG. 1B (illustrating wire loops 112a and 112b), FIG. 1C (illustrating wire loops 112g and 112h), and FIG. 1D (illustrating wire loop 112f). FIGS. 2A-2B are additional side, and top, views of workpiece 105 illustrating wire loops 112a (providing interconnection between bond pad 108a2 of semiconductor element 108 and lead 106a2 of substrate 106), 112b (providing interconnection between bond pad 108a1 of semiconductor element 108 and lead 106a1 of substrate 106), 112c (providing interconnection between bond pad 108a4 of semiconductor element 108 and lead 106a4 of substrate 106), 112d (providing interconnection between bond pad 108a3 of semiconductor element 108 and lead 106a3 of substrate 106), 112e (providing interconnection between bond pad 108a5 of semiconductor element 108 and lead 106a5 of substrate 106), 112f (providing interconnection between bond pad 108a9 of semiconductor element 108 and bond pad 110a1 of semiconductor element 110), 112g(providing interconnection between bond pad 108a11 of semiconductor element 108 and bond pad 110a3 of semiconductor element 110), 112h (providing interconnection between bond pad 108a10 of semiconductor element 108 and bond pad 110a2 of semiconductor element 110), 112i (providing interconnection between bond pad 108a7 of semiconductor element 108 and lead 106a7 of substrate 106), 112j (providing interconnection between bond pad 108a6 of semiconductor element 108 and lead 106a6 of substrate 106), and 112k (providing interconnection between bond pad 108a8 of semiconductor element 108 and lead 106a7 of substrate 106).

Referring specifically to FIG. 1B, wire loops 112a and 112b, which overlap one another (see FIG. 1B and FIG. 2B), are illustrated. By “overlap”, it should be understood that at least a portion of a wire loop is positioned directly (or in close proximity) over another wire loop (e.g., a first bond, a wire length, etc.). Wire loop 112a includes: wire bond 112a0 (i.e., a first bond) and wire bond 112a4 (i.e., a second bond, a stitch bond); wire sections 112a1, 112a2, and 112a3; and wire bends 112a1′ and 112a2′. Wire loop 112b includes: wire bond 112b0 (i.e., a first bond) and wire bond 112b4 (i.e., a second bond, a stitch bond); wire sections 112b1, 112b2, and 112b3; and wire bends 112b1′ and 112b2′. A wire loop shape of wire loop 112a and/or wire loop 112b may include respective: locations of the wire bonds; locations (e.g., three dimensional locations) of each of the plurality of wire bends; and lengths of wire to be included in each of the wire sections.

Referring specifically to FIG. 1C, wire loops 112g and 112h, which are beside/adjacent one another (see FIG. 1C and FIG. 2B), are illustrated. Wire loop 112h includes: wire bond 112h0 (i.e., a first bond) and wire bond 112h5 (i.e., a second bond, a stitch bond); wire sections 112h1, 112h2, 112h3 and 112h4; and wire bends 112h1′, 112h2′ and 112h3′. Thus, as compared to wire loops 112a, 112b, and 112g, wire loop 112h has an additional bend. A wire loop shape of wire loop 112h may include: locations of the wire bonds; locations (e.g., three dimensional locations) of each of the plurality of wire bends; and lengths of wire to be included in each of the wire sections.

Referring specifically to FIG. 1D, wire loop 112f is illustrated. Wire loop 112f includes: wire bond 112f5 (e.g., a bump bond, a standoff), wire bond 112f0, and wire bond 112f4 (i.e., a stitch bond onto wire bond 112f5, illustrated in a combined bond); wire sections 112f1, 112f2, and 112f3; and wire bends 112f1′ and 112f2′. A wire loop shape of wire loop 112f may include: locations of the wire bonds; locations (e.g., three dimensional locations) of each of the plurality of wire bends; and lengths of wire to be included in each of the wire sections.

As will be appreciated by those skilled in the art, wire loop 112f may be formed as follows: first, a free air ball is bonded to a bonding location on semiconductor element 110 to form wire bond 112f5; then, another free air ball is formed and bonded to a bonding location on semiconductor element 108 to form wire bond 112f0; then, a length of wire is extended (continuous with wire bond 112f0) in the shape of wire loop 112f to wire bond 112f5; then, the end of the wire is bonded to wire bond 112f5 to form wire bond 112f4 (e.g., a stitch bond). Thus, wire loop 112f is an example of a wire loop formed using so called “up bonding”, where the wire loop process goes from a lower location (e.g., a bonding location on semiconductor element 108) “up” to a higher location (e.g., a bonding location on semiconductor element 110), or at least to a location at the same height. This is in contrast to the process used to form the other wire loops shown in FIGS. 1A-1D, which is sometimes referred to as “down bonding”, where the wire loop process goes from a higher location (e.g., a bonding location on semiconductor element 108) “down” to a lower location (e.g., a bonding location on substrate 106.). The decision of whether to form a wire loop using an “up bonding” process or a “down bonding” process may be made as part of the process of generating the wire loop shape of the wire loop.

FIGS. 2A-2B illustrate workpiece 105 previously described with respect to FIGS. 1A-1D. FIG. 2A illustrates three different “loop tier values” of wire loops. That is, each wire loop may be assigned a loop tier value. For example, the assigned loop tier value may be related to the specific row of die pads of a semiconductor element. More specifically, certain rows of die pads may be assigned one loop tier value, while other rows of die pads may be assigned a different loop tier value. In another example, the assigned loop tier value may be related to a wire loop height.

In the example shown in FIG. 2A, wire loops 112a, 112c, 112d, 112i, 112j, and 112k are “tier 1” wire loops (e.g., these wire loops have the lowest loop height) (where tier 1 is marked as “T1”). Wire loops 112b, 112e, 112f, and 112g are “tier 2” wire loops (e.g., these wire loops have an intermediate loop height) (where tier 2 is marked as “T2”). Wire loop 112h is a “tier 3” wire loop (e.g., this wire loop has the highest loop height) (where tier 3 is marked as “T3”). Of course, FIG. 2A is just one simple example of a workpiece; that is, a workpiece may include wire loops having more than 3 loop tier values (e.g., stacked die applications). In connection with aspects of the invention, loop tier values may be generated for each of the plurality of wire loops to be included in a semiconductor package (or other workpiece).

FIG. 2B is an overhead view of workpiece 105 illustrating various conditions that may be considered in connection with the invention (e.g., considerations in generating wire loop shapes for each of the plurality of wire loops, considerations in generating loop tier values for each of the plurality of wire loops, etc.). For example, wire loop 112b overlaps wire loop 112a. Likewise, wire loop 112d overlaps wire loop 112c. Wire loop shapes generated in connection with the invention may include bends in multiple planes of a semiconductor package. Wire loop 112d includes such a bend-that is, wire loop 112d includes an extra “lateral” bend because of the overlap condition. Further, wire loops generated in connection with the invention may consider “cluster” bonding conditions where more than one wire bond is formed on a single bonding location (e.g., see wire loops 112i and 112k in FIG. 2B, each of which is bonded to bonding location 106a7).

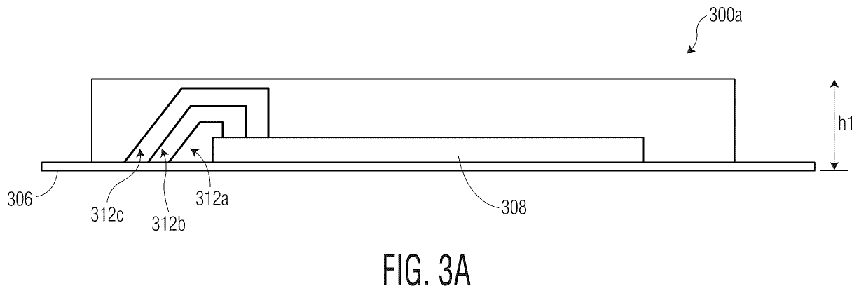

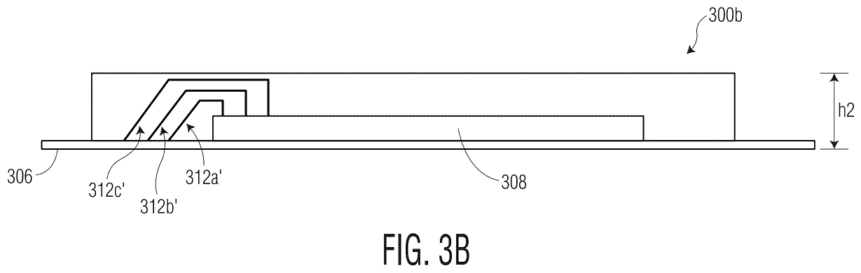

In the design of conventional semiconductor packages, a package size (e.g., including a semiconductor package height, such as an end-state or “final” semiconductor package height) is provided as a constraint. Using this size information (e.g., including a semiconductor package height), a manual layout of the wire loops may be provided that fits within this size. For example, referring to FIG. 3A, a semiconductor package 300a (including a semiconductor element 308 supported by a substrate 306) is illustrated where a package height is provided as “h1”. Conventionally, it may be desirable to use the space allotted within the package size to separate the wire loops as much as possible. Thus, wire loops 312a, 312b, and 312c are oriented to have a maximum spacing to use the space allotted within the package size.

In contrast, FIG. 3B illustrates a semiconductor package 300b (including semiconductor element 308 supported by substrate 306), where the package height is not provided. Rather, aspects of the invention include generating the wire loop shapes (e.g., automatically) for each of the plurality of wire loops in an effort to minimize a height of the semiconductor package; and/or generating the wire loop shapes for each of the plurality of wire loops in an effort to optimize spacing in the semiconductor package. Thus, wire loop shapes are provided for each wire loops 312a′, 312b′, and 312c′. These wire loop shapes are generated to have the required spacing, but not excess spacing-and as such, the resultant package height “h2” is much smaller than the conventional package height.

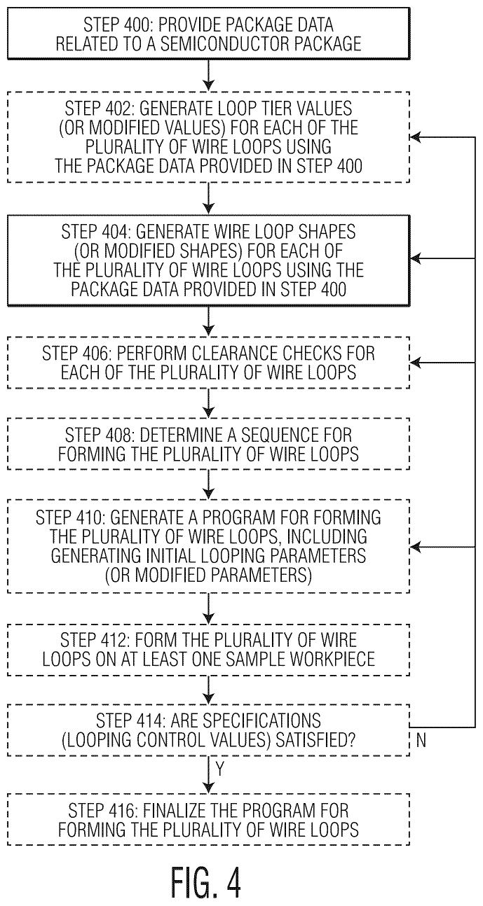

FIG. 4 is a flow diagram illustrating a method of determining (e.g., automatically determining, for example, using one or more computers) wire loop shapes for a plurality of wire loops configured to be included in a semiconductor package. As is understood by those skilled in the art, certain steps included in the flow diagram may be omitted; certain additional steps may be added; and the order of the steps may be altered from the order illustrated-all within the scope of the invention. Any or all of the steps illustrated and described in connection with FIG. 4 may also be used in connection with methods of generating a semiconductor package design in connection with the invention.

As will be appreciated by those skilled in the art, any one or more of Steps 400-416 may be performed using a computer (e.g., computer 118, 120 illustrated in FIG. 1A) or computers. Such a computer may be on a wire bonding system (e.g., computer 118) or separate from a wire bonding system (e.g., computer 120). Any one or more of Steps 400-416 may be performed using an algorithm(s) running on a computer.

At Step 400, package data related to the semiconductor package is provided. Step 400 may also include assembling the package data in a data structure accessible by a computer (e.g., see computer 118 and/or computer 120 shown in FIG. 1A). Specific data that may be included in the package data are: thickness values related to at least one of (i) a semiconductor element in the semiconductor package and (ii) the semiconductor package; loop tier values for each of the plurality of wire loops; position data related to components included in the semiconductor package; at least one two-dimensional drawing including a wire layout for the semiconductor package; and/or a maximum loop height specification for the semiconductor package.

At optional Step 402, loop tier values are generated for each of the plurality of wire loops using the package data provided in Step 400. For example, see FIG. 2A, and the related preceding description explaining “loop tier values” for each of the plurality of wire loops (e.g., tier 1 wire loops, tier 2 wire loops, tier 3 wire loops, etc.). That is, by analyzing the package data, the loop tier values may be automatically generated.

At Step 404, wire loop shapes are generated (e.g., automatically generated) for each of the plurality of wire loops using the package data provided in Step 400. For example, elements of the package data utilized in Step 404 may be overlap conditions between ones of the plurality of wire loops, wire loop heights of ones of the plurality of wire loops, lateral bend conditions between ones of the plurality of wire loops, and wire loop positions for ones of the plurality of wire loops. For example, the generated wire loop shapes may include one or more of the following: three-dimensional wire loop shapes; three-dimensional locations for each of a plurality of bends configured to be included in each of the plurality of wire loops; a length of wire to be included between each of the plurality of bends (and/or a length of wire to be included between a bend and an adjacent wire bond); wire lengths for each of a plurality of sections of each of the plurality of wire loops; a wire loop height for each of the plurality of wire loops; and bends in multiple planes of the semiconductor package (e.g., lateral bends such as the lateral bend included in wire loop 112d shown in FIG. 2B). The generation of the wire loop shapes in Step 404 may also include the decision of whether to form a wire loop using an “up bonding” process or a “down bonding” process.

At optional Step 406, clearance checks are performed for each of the plurality of wire loops. For example, U.S. Pat. No. 10,325,878 discloses checking if an acceptable level of clearance exists between adjacent loop profiles, where the loop profiles include a tolerance band along at least a portion of a length of a wire loop.

It will be appreciated that the clearance check performed at Step 406 may (or may not) be superfluous. That is, according to certain exemplary embodiments of the invention, Step 402 (generating the loop tier values for the plurality of wire loops) and/or Step 404 (generating the wire loop shapes for the plurality of wire loops) are completed in an effort to ensure adequate clearance between the plurality of wire loops.

At optional Step 408, a sequence for forming the plurality of wire loops is determined. For example, U.S. Pat. No. 12,183,711 discloses methods of determining a sequence for creating a plurality of wire loops in connection with a workpiece. Such techniques may be used in connection with Step 408.

At optional Step 410, a program for forming the plurality of wire loops is generated, including generating initial looping parameters. For example, U.S. Pat. No. 9,496,240 discloses deriving looping parameters using an algorithm. Such looping parameters may be part of a program generated for forming the plurality of wire loops. At optional Step 412, the plurality of wire loops are formed on at least one sample workpiece. At optional Step 414, a determination is made as to whether specifications are satisfied-such as by looping control values. For example, U.S. Pat. No. 9,496,240 discloses measuring actual looping control values and comparing such actual looping control values to a looping control value provided related to a desired wire loop. For example, if the actual looping control values measured are within an acceptable range of the looping control value provided related to a desired wire loop, then the specifications may be considered as being met. Of course, multiple specifications may be required to be met (e.g., multiple looping control value comparisons as in U.S. Pat. No. 9,496,240).

If the specifications are met at Step 414 (a “Y” at Step 414), then the process proceeds to Step 416. At Step 416, the program for forming the plurality of wire loops is finalized.

If one or more of the specifications are not met at Step 414 (a “N” at Step 414), then the process returns to one or more of Steps 402, 404, 406 and 410 in a closed loop until the specifications are met at Step 414 (a “Y” at Step 414), such that the process proceeds to Step 416 where the program for forming the plurality of wire loops is finalized. Thus, each of Steps 402, 404 and 410 may involve modifying the relevant information.

That is: if the closed loop returns to Step 402, modified loop tier values may be generated (where the loop tier value of one or more of the wire loops may automatically be modified); if the closed loop returns to Step 404, modified wire loop shapes may be generated (where the wire loop shape of one or more of the wire loops may automatically be modified); and/or if the closed loop returns to Step 410, modified looping parameters may be generated (where the looping parameters for one or more of the wire loops may automatically be modified).

As provided above, each of the steps shown in FIG. 4 may be performed using a computer (e.g., computer 118, 120 illustrated in FIG. 1A) or computers, for example, using one or more algorithms. Thus, the entire process from Step 400 (e.g., providing the package data) through Step 416 (e.g., the finalization of the program for forming the plurality of wire loops)—or any part of the process, as desired—may be initiated and completed in a single step (e.g., a single click or process initiation).

Any one or more of the steps illustrated in FIG. 4 may also be used in connection with a method of generating a semiconductor package design, where the semiconductor package is configured to include a plurality of wire loops. Such a method includes the steps of: providing package data related to the semiconductor package (Step 400); generating wire loop shapes for each of the plurality of wire loops using the package data; and providing design information related to a height of the semiconductor package based on the wire loop shapes generated. Such a method may also include any one or more of the additional steps illustrated in FIG. 4.

Although various aspects of the invention may be accomplished using a computer on a wire bonding system—in many applications it will be more efficient to use an offline computer(s) to accomplish the inventive methods. For example, the wire loop shapes (and/or the loop tier values) may be generated offline (not on a wire bonding system).

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method of determining wire loop shapes for a plurality of wire loops configured to be included in a semiconductor package, the method comprising the steps of:
(a) providing package data related to the semiconductor package; and
(b) generating wire loop shapes for each of the plurality of wire loops using the package data provided in step (a).

2. The method of claim 1 wherein the wire loop shapes are three-dimensional wire loop shapes.

3. The method of claim 1 wherein the wire loop shapes include three-dimensional locations for each of a plurality of bends configured to be included in each of the plurality of wire loops.

4. The method of claim 3 wherein the wire loop shapes further include a length of wire to be included between each of the plurality of bends.

5. The method of claim 1 wherein the wire loop shapes include wire lengths for each of a plurality of sections of each of the plurality of wire loops.

6. The method of claim 1 wherein the wire loop shapes include bends in multiple planes of the semiconductor package.

7. The method of claim 1 wherein the package data includes locations of wire bonds of each of the plurality of wire loops.

8. The method of claim 1 wherein the package data includes thickness values related to at least one of (i) a semiconductor element in the semiconductor package and (ii) the semiconductor package.

9. The method of claim 1 wherein the package data includes loop tier values for bonding locations configured to receive wire bonds in connection with formation of the plurality of wire loops.

10. The method of claim 1 wherein the package data includes position data related to components included in the semiconductor package.

11. The method of claim 1 wherein the package data includes at least one two-dimensional drawing including a wire layout for the semiconductor package.

12. The method of claim 1 wherein the package data includes a maximum loop height specification for the semiconductor package.

13. The method of claim 1 wherein step (a) includes teaching locations of wire bonds of each of the plurality of wire loops.

14. The method of claim 1 further comprising the step of generating loop tier values for each of the plurality of wire loops using the package data provided in step (a).

15. The method of claim 1 wherein step (b) includes generating the wire loop shapes for each of the plurality of wire loops in an effort to minimize a height of the semiconductor package.

16. The method of claim 1 wherein step (b) includes generating the wire loop shapes for each of the plurality of wire loops in an effort to optimize spacing in the semiconductor package.

17. A method of generating a semiconductor package design including a plurality of wire loops, the method comprising the steps of:
(a) providing package data related to the semiconductor package; and
(b) generating wire loop shapes for each of the plurality of wire loops using the package data provided in step (a); and
(c) providing design information related to a height of the semiconductor package based on the wire loop shapes generated in step (b).

18. The method of claim 17 wherein the wire loop shapes are three-dimensional wire loop shapes.

19. The method of claim 17 wherein the wire loop shapes include three-dimensional locations for each of a plurality of bends configured to be included in each of the plurality of wire loops.

20. The method of claim 19 wherein the wire loop shapes further include a length of wire to be included between each of the plurality of bends.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)
